(19) United States
(12) Patent Application Publication
(10) Pub. No.: US 2012/0221969 A1
(43) Pub. Date: Aug. 30, 2012

(54) SCROLLABLE LIST NAVIGATION USING PERSISTENT HEADINGS

(75) Inventors: Chigusa Yasuda Sansen, Bellevue, WA (US); Tammy Culter Paine, Redmond, WA (US)

(73) Assignee: Microsoft Corporation, Redmond, WA (US)

(21) Appl. No.: 13/037,100

(22) Filed: Feb. 28, 2011

(51) Int. Cl. G06F 3/048

(52) U.S. Cl. 715/784; 715/810

(57) ABSTRACT

The present application discloses a scrollable list that uses headings for easy navigation in the list. In one embodiment, at least one heading is persistently visible on the user interface so that if a user clicks on the persistent heading, a separate window displaying headings is automatically opened. The user can then click on any of the headings to jump in the list to that heading. In another aspect, if the list is below a predetermined number of entries, the headings are automatically eliminated altogether to facilitate visibility of the list.

### FIELD

The present application relates generally to user interfaces, and, more particularly, to scrolling through lists in a user interface.

### BACKGROUND

Current phones display a list of contacts alphabetically with letter headings dividing the list into groups. For example, a letter “A” starts the list as a heading followed by all names starting with that letter (e.g. Andrew). After displaying the last contact starting with a letter “A”, a heading of “B” is displayed followed by contacts starting with that letter, and so on. The ability to navigate quickly is limited and, the longer the list, the longer it takes to find a contact. Newer phones have the ability to click on a heading in order to open a new window displaying only the headings in the list. Navigation can be expedited by simply clicking on whatever heading is desirable and the user interface jumps to the selected heading in the list. One problem with this user interface, is that for long lists, the heading scrolls off the display and the user must scroll to search for a heading to click on.

### SUMMARY

The present application overcomes the deficiencies of the prior art by persistently displaying at least one heading visible on the user interface so that if a user clicks on the persistent heading, a window displaying only headings is automatically opened. The user can then click on any of the headings to jump in the list to that heading.

In another aspect, if the list is below a predetermined number of entries, the headings are automatically eliminated altogether, as the headings clutter the user interface and lengthen the list, rather than facilitate scrolling.

With at least one heading always positioned at the top of the list (even while the user scrolls), the user can always know where to click in order to access a quick jump list. Once the quick jump list is opened, the user to easily navigate within the displayed list.

This Summary is a general overview and is not intended to limit or define the scope of the claimed subject matter. The foregoing and other objects, features, and advantages of the invention will become more apparent from the following detailed description, which proceeds with reference to the accompanying figures.

### BRIEF DESCRIPTION OF THE DRAWINGS

FIG. 1 is a diagram of an exemplary mobile device that can be used to implement the scrollable list navigation with persistent headings.

FIG. 2 is a flowchart of a method to persistently display at least one selectable heading.

FIG. 3 is a diagram illustrating a list with headings shown as the user scrolls.

FIG. 4 is a diagram illustrating a later point in time than FIG. 3, with the list actively scrolling.

FIG. 5 is a diagram illustrating a later point in time than FIG. 4, with the list actively scrolling and a transition occurring between headings located at the top of the list.

FIG. 6 is a diagram illustrating a later point in time than FIG. 5, with the transition completed between headings.

FIG. 7 shows a user selecting (i.e., clicking) on a heading in a list.

FIG. 8 shows a quick jump list displayed in response to the selecting of FIG. 7.

FIG. 9 shows a user selecting a heading in the quick jump list and jumping to a corresponding location in the list.

FIG. 10 shows an alternative transition that can be used between headings.

FIG. 11 shows a progression as a transition occurs from a heading to another.

FIG. 12 is a flowchart of a method for using a quick jump list.

FIG. 13 is a flowchart of another embodiment wherein headings are removed for smaller lists.

FIG. 14 is an example list with the headings removed.

FIG. 15 is a system diagram illustrating that the list can be used on alternative platforms.

### DETAILED DESCRIPTION

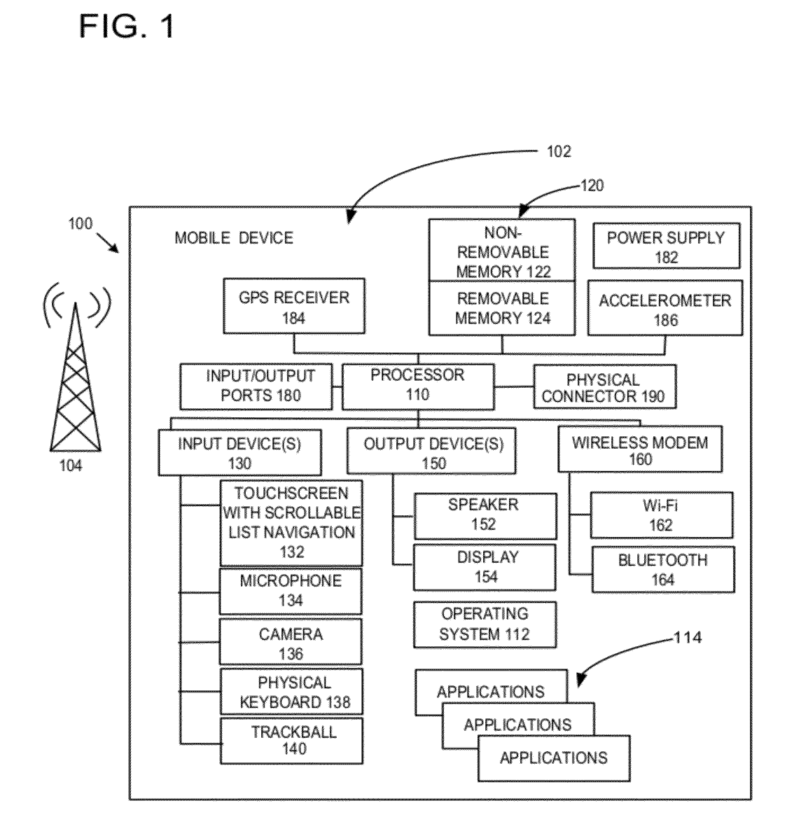

FIG. 1 is a system diagram depicting an exemplary mobile device 100 including a variety of optional hardware and software components, shown generally at 102. Any components 102 in the mobile device can communicate with any other component, although not all connections are shown, for ease of illustration. The mobile device can be any of a variety of computing devices (e.g., cell phone, smartphone, handheld computer, Personal Digital Assistant (PDA), etc.) and can allow wireless two-way communications with one or more mobile communications networks 104, such as a cellular or satellite network.

The illustrated mobile device 100 can include a controller or processor 110 (e.g., signal processor, microprocessor, ASIC, or other control and processing logic circuitry) for performing such tasks as signal coding, data processing, input/output processing, power control, and/or other functions. An operating system 112 can control the allocation and usage of the components 102 and support for one or more application programs 114. The application programs can include common mobile computing applications (e.g., email applications, calendars, contact managers, web browsers, messaging applications), or any other computing application.

The illustrated mobile device 100 can include memory 120. Memory 120 can include non-removable memory 122 and/or removable memory 124. The non-removable memory 122 can include RAM, ROM, flash memory, a hard disk, or other well-known memory storage technologies. The removable memory 124 can include flash memory or a Subscriber Identity Module (SIM) card, which is well known in GSM communication systems, or other well-known memory storage technologies, such as “smart cards.” The memory 120 can be used for storing data and/or code for running the operating system 112 and the applications 114. Example data can include web pages, text, images, sound files, video data, or other data sets to be sent to and/or received from one or more network servers or other devices via one or more wired or wireless networks. The memory 120 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 100 can support one or more input devices 130, such as a touch screen 132 (which can implement the scrollable list navigation described herein), microphone 134, camera 136, physical keyboard 138 and/or trackball 140 and one or more output devices 150, such as a speaker 152 and a display 154. Other possible output devices (not shown) can include piezoelectric or other haptic output devices. Some devices can serve more than one input/output function. For example, touchscreen 132 and display 154 can be combined in a single input/output device.

A wireless modem 160 can be coupled to an antenna (not shown) and can support two-way communications between the processor 110 and external devices, as is well understood in the art. The modem 160 is shown generically and can include a cellular modem for communicating with the mobile communication network 104 and/or other radio-based modems (e.g., Bluetooth or Wi-Fi). The wireless modem 160 is typically configured for communication with one or more cellular networks, such as a GSM network for data and voice communications within a single cellular network, between cellular networks, or between the mobile device and a public switched telephone network (PSTN).

The mobile device can further include at least one input/output port 180, a power supply 182, a satellite navigation system receiver 184, such as a Global Positioning System (GPS) receiver, an accelerometer 186, and/or a physical connector 190, which can be a USB port, IEEE 1394 (FireWire) port, and/or RS-232 port. The illustrated components 102 are not required or all-inclusive, as any components can deleted and other components can be added.

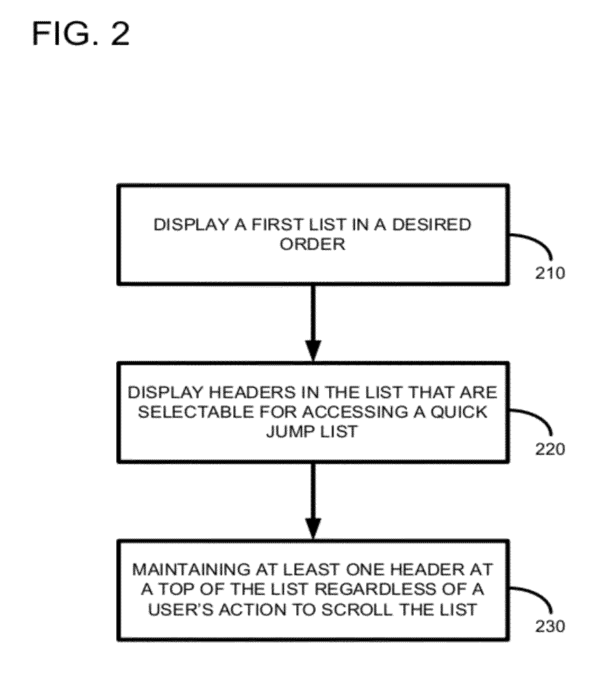

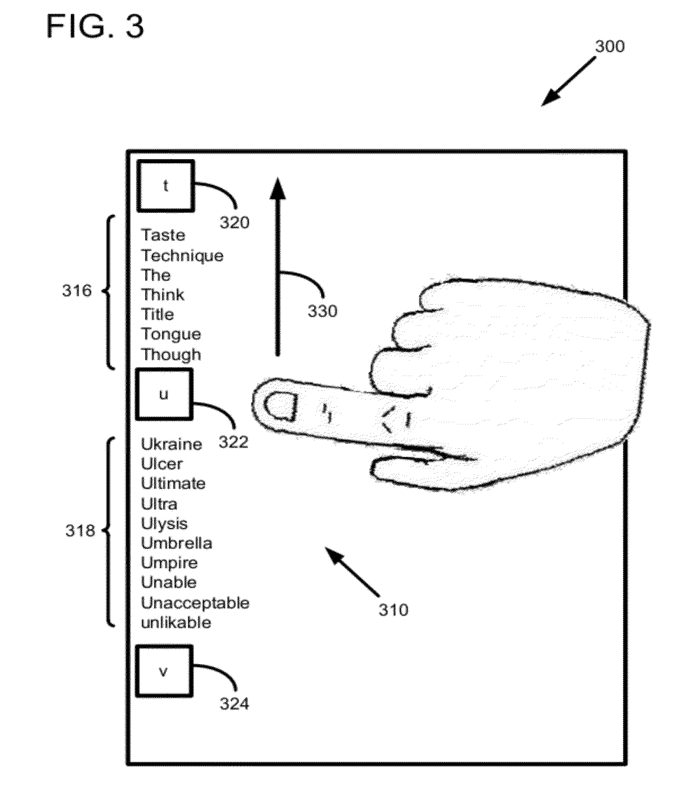

FIG. 2 is a flowchart of a method for navigating in a list. In process block 210, a first list is displayed in a desired order. The list can be any list, such as a list derived from a list of contacts. For example, an alphabetic list of names or titles can be displayed. Alternatively, a non-alphabetic list can be used. Examples of headers used in lists include dates, categories, colors, etc. In process block 220, headers are integrated into the list to divide the list into sub-portions. For example, the headings can be the letters “A”, “B”, “C”, etc. that divide the list based on the first letter of each word in the list. The headings can be selectable for accessing a quick jump list. The quick jump list can be, for example, a list of the headings that are selectable for jumping within the list. In process block 230, at least one header is maintained at a top of the list regardless of the user's action to scroll the list. In such a way, a heading is always available for the user to select and access the quick jump list. As described herein, “persistently” displaying means that at least one header is maintained at the top of a list, as shown in FIGS. 3-6. In an alternative embodiment, the persistent heading can be at a position other than the top of the list.

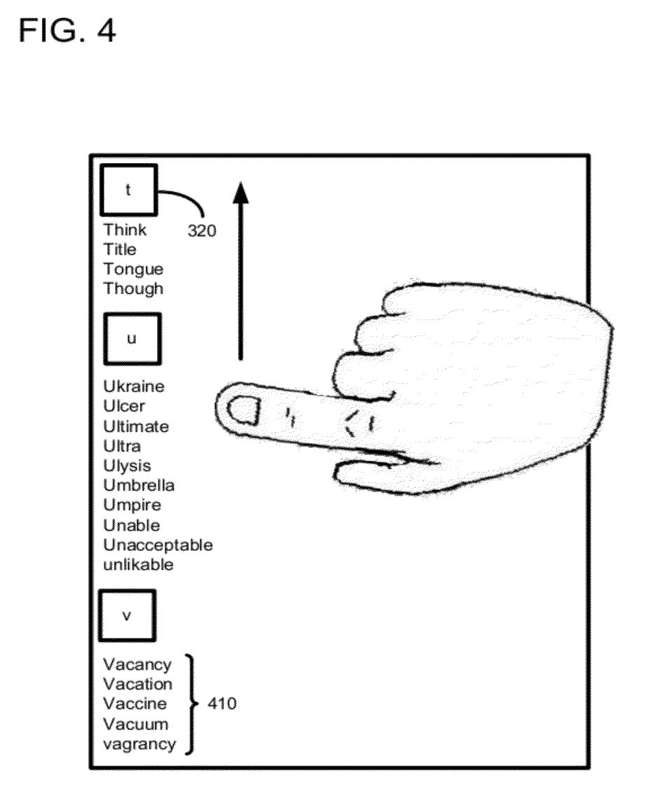

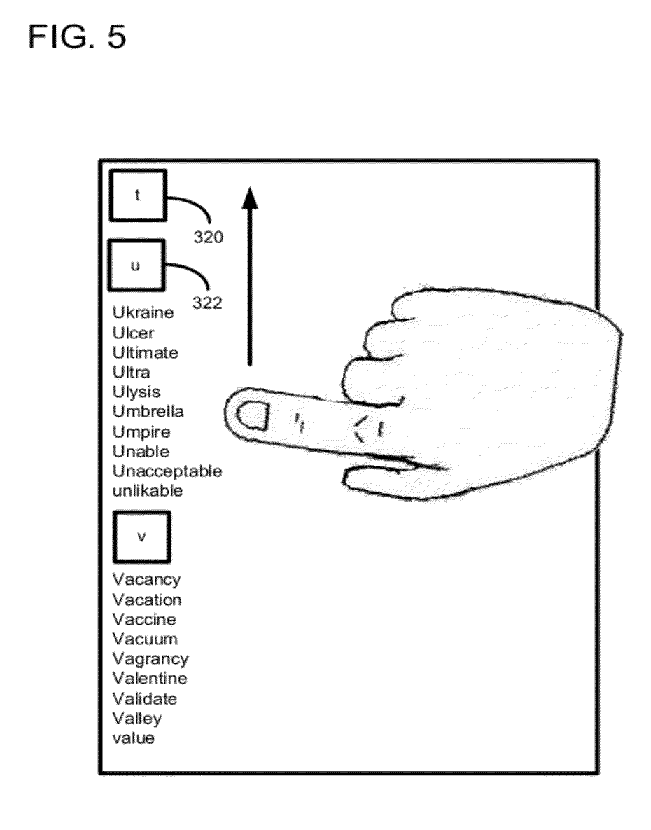

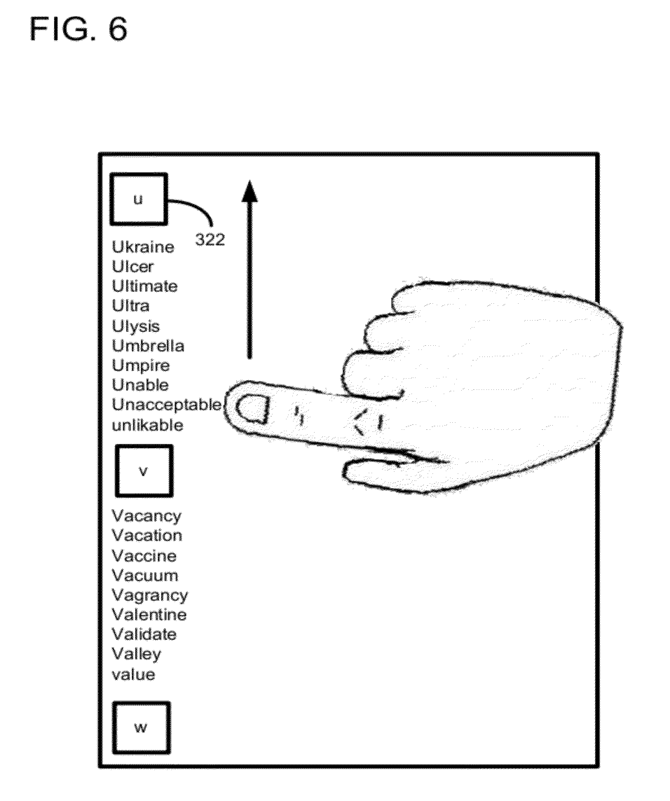

FIGS. 3-6 show a progression of screen shots as a list is being scrolled. FIG. 3 is an example user interface 300. A portion of a list 310 is shown having sections 316, 318 divided by headings 320, 322, and 324. The list can be scrolled in a direction shown by arrow 330 or in the opposite direction. As can be seen, the heading 320 is at a top-most portion of the list. FIG. 4 shows that the list of FIG. 3 is being scrolled with new members 410 of the list coming into view, while other members have already scrolled off the viewing area. Nonetheless, header 320 remains in the top-most portion of the list and does not change its position. By maintaining a header at the top of the list, the header 320 changes its position relative to the list as the list is being scrolled. FIG. 5 shows heading 322 adjacent to heading 320 as a transition occurs between headings. Thus, more than one heading can also be displayed at the top of the list. The last word starting with the letter “t” has scrolled off the list so that only the heading 320 remains. As the list continues to scroll, the letter “t” scrolls off the user interface and is replaced with the heading 322, the letter “u”, as shown in FIG. 6. As a result, at least one heading is continuously displayed at the top of the list and is in a consistent location on the user interface.

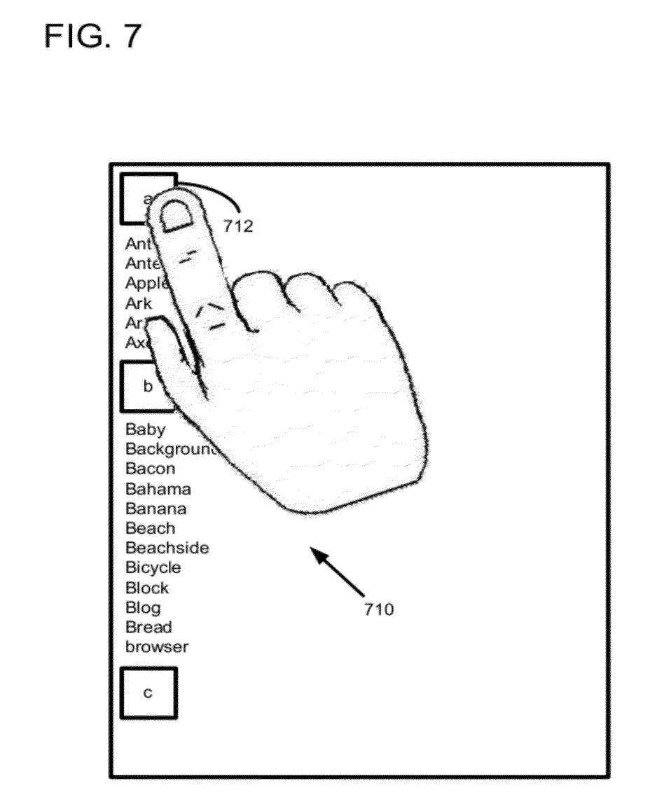

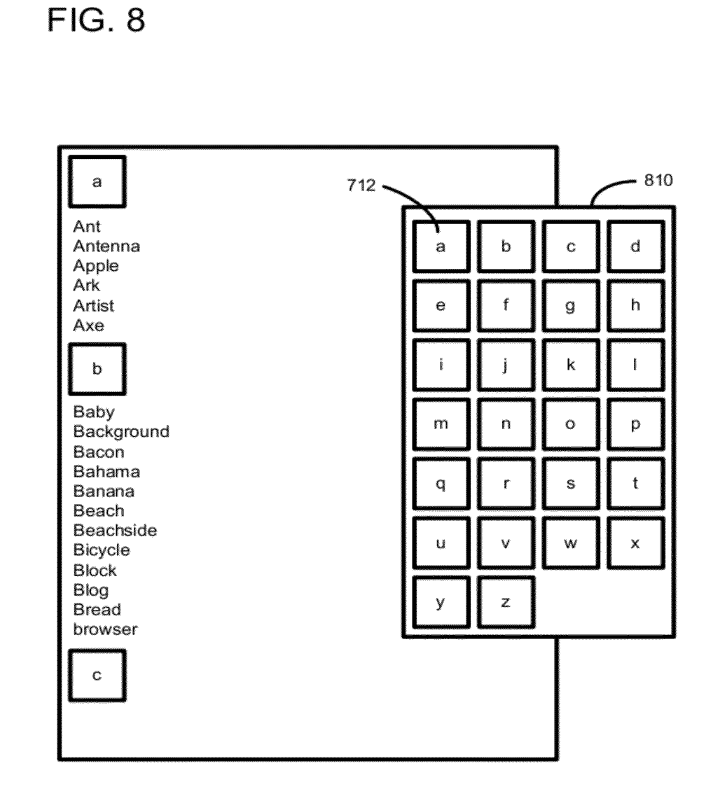

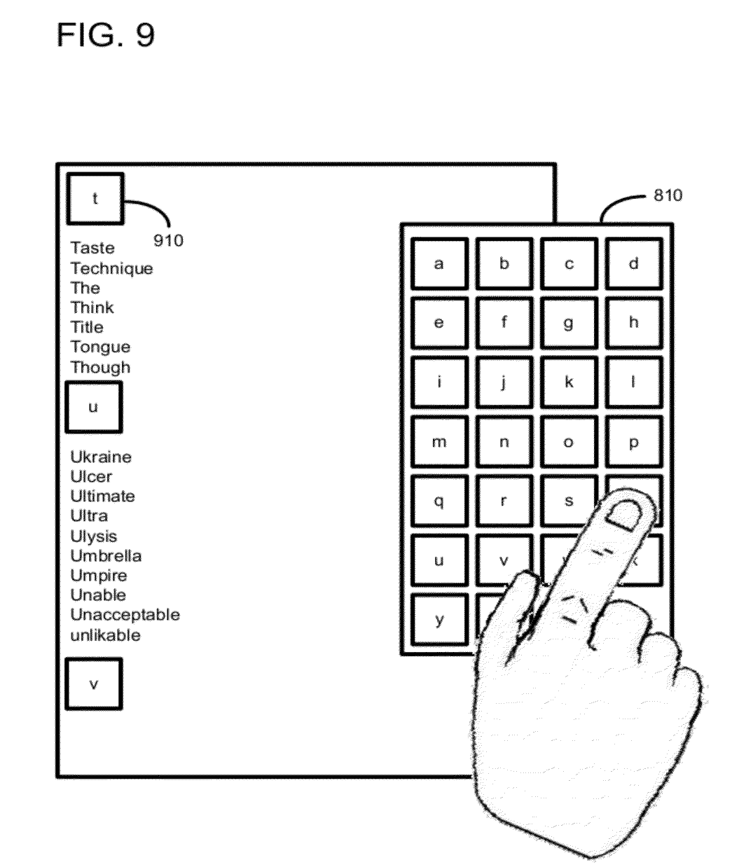

FIGS. 7-9 show a progression as a user navigates a list 710. FIG. 7 shows the list 710 with multiple headings. A user is selecting a heading 712 by touching the user interface at the location of the heading. In other words, the headings are clickable (i.e., actionable). FIG. 8 shows that in response to receiving an input selection of the heading, a quick jump list (i.e., a second list) 810 is displayed. In one embodiment, the quick jump list is displayed in a separate window than the list 710 (the window can completely overlap the first list). Alternatively, the quick jump list can be placed in the same window. The quick jump list 810 includes the headings from the list 710, such as heading 712. In the present illustration, the quick jump list 810 includes each letter of the alphabet, which is all of the headings from the list 710. In FIG. 9, an input selection is received indicating that the user selected the heading “t” in the quick jump list 810, which automatically scrolls or jumps in the list 710 so that “t” is the heading 910 at the top of the list. In this way, the user can quickly navigate to any heading in the list.

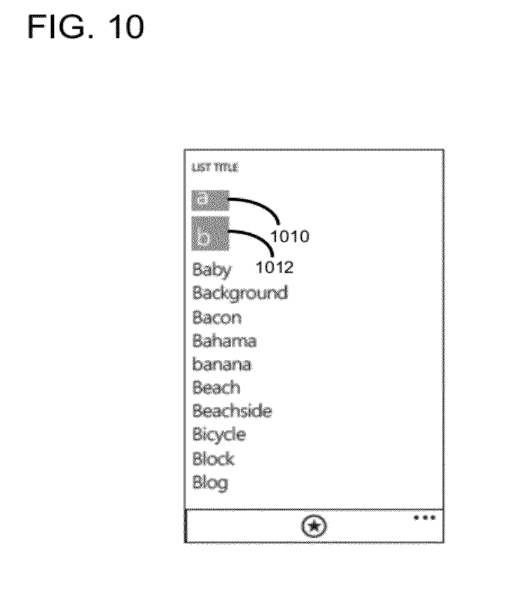

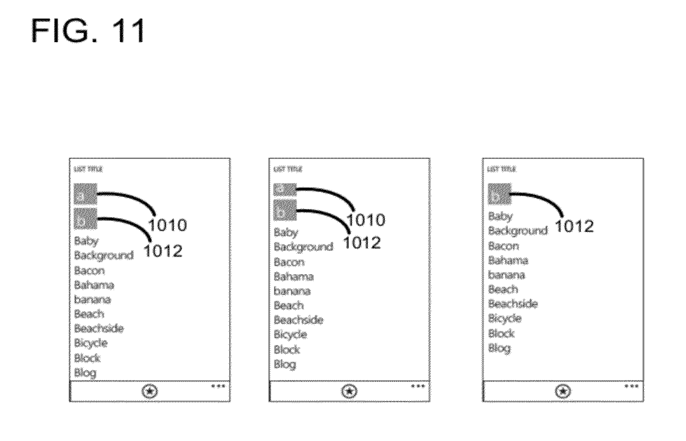

FIG. 10 illustrates a transition that can occur as a first heading 1010 scrolls off of the user interface and is replaced by a second heading 1012. As the first heading 1010 scrolls off the user interface, it follows the list behavior so that it can be only partially showing. The illustrated heading 1010 is only half showing and is partially cutoff at the top. Thus, the header can be designed to track movement of the list, rather than moving the list to ensure the header is fully displayed. FIG. 11 also shows the transition as the first heading 1010 scrolls off the user interface and the second heading 1012 scrolls into a top position on the list. As can readily be seen, the letter “a” transitions from being fully visible, to partially visible, to off the user interface.

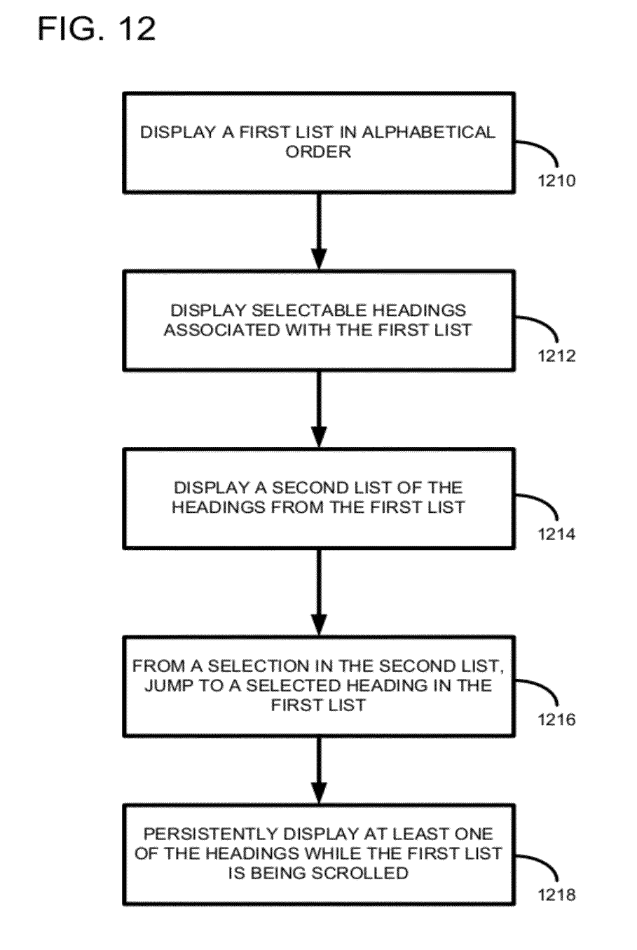

FIG. 12 is a flowchart of a method for persistently displaying a heading in a list. In process block 1210, a first list is displayed in alphabetical order. In process block 1212, selectable headings are displayed that are associated with the first list and that divide the first list into sections. Input can be received selecting one of the headings. In process block 1214, in response to the selection, a second list is displayed that includes only the headings from the first list. Input can be received selecting one of the headings in the second list. In process block 1216, in response to the selection a jump can be made to the same heading in the first list. In process block 1218, at least one of the headings in the first list is persistently displayed at a top of the list.

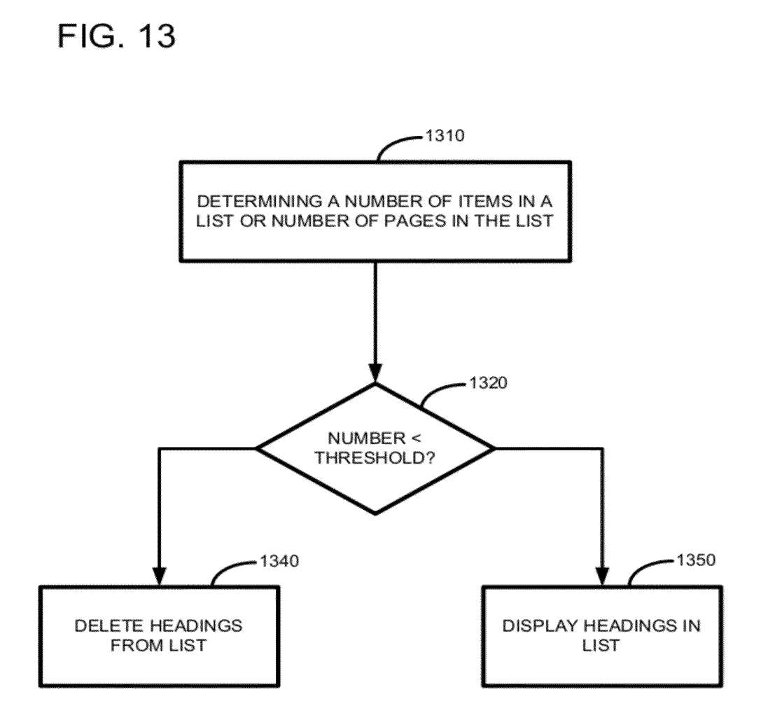

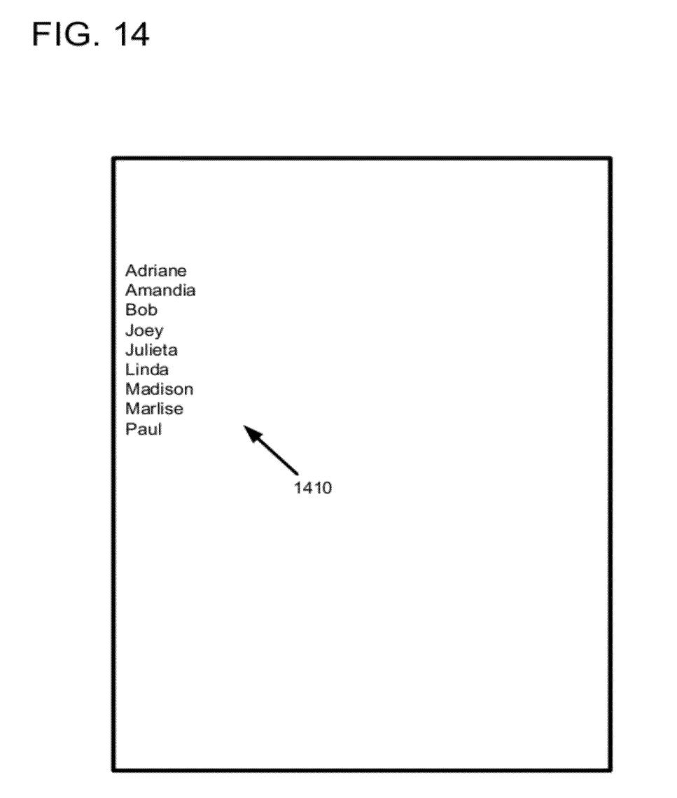

FIG. 13 is a flowchart of a method for determining whether headings should be displayed at all. It was found that if the list is small, the headings can be eliminated or suppressed altogether. In process block 1310, a determination is made of a number of items in the list or the number of pages in the list. For example, a simple count can be done. In decision block 1320, if the number of items or the number of pages is below a threshold then in process block 1340, the headings are deleted from the list (or otherwise not inserted). If the number of items or the number of pages is above the threshold, then in process block 1350 the headings are included in the list. The method can be used upon displaying the list. Additionally, if an item is added or deleted, the list can go from no headings to the headings being inserted or vice versa. FIG. 14 shows an example list 1410 without headings.

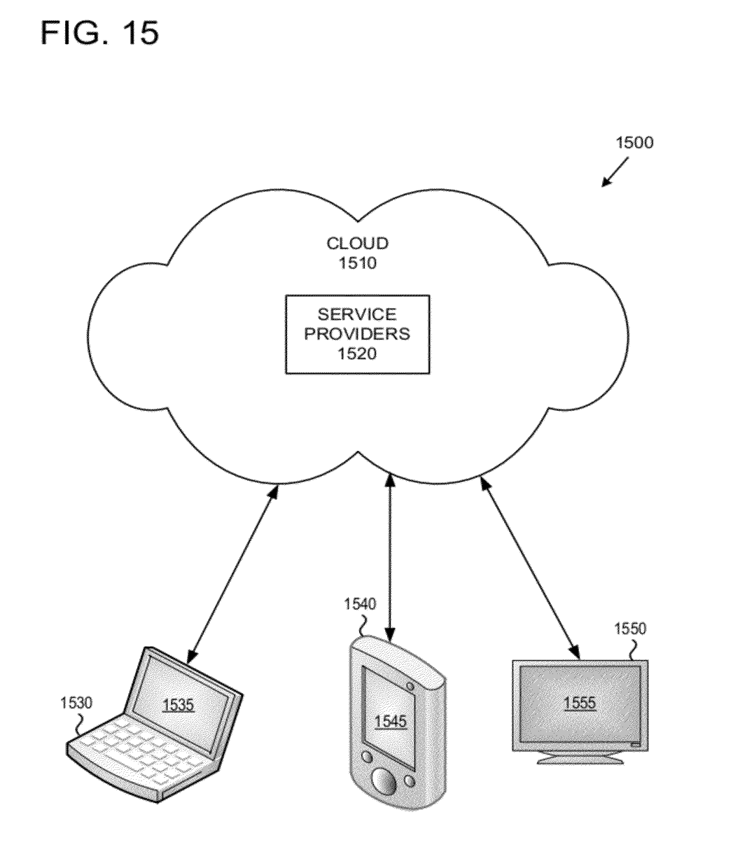

FIG. 15 illustrates a generalized example of a suitable implementation environment 1500 in which described embodiments, techniques, and technologies may be implemented.

In example environment 1500, various types of services (e.g., computing services) are provided by a cloud 1510. For example, the cloud 1510 can comprise a collection of computing devices 1530, 1540, 1550, which may be located centrally or distributed, that provide cloud-based services to various types of users and devices connected via a network such as the Internet. The implementation environment 1500 can be used in different ways to accomplish computing tasks. For example, some tasks (e.g., processing user input and presenting a user interface) can be performed on local computing devices (e.g., connected devices 1530-1532) while other tasks (e.g., storage of data to be used in subsequent processing) can be performed in the cloud 1510.

In example environment 1500, the cloud 1510 provides services for connected devices 1530, 1540 1550 with a variety of screen capabilities. Connected device 1530 represents a device with a computer screen 1535 (e.g., a mid-size screen). For example, connected device 1530 could be a personal computer such as desktop computer, laptop, notebook, netbook, or the like. Connected device 1540 represents a device with a mobile device screen 1545 (e.g., a small size screen). For example, connected device 1540 could be a mobile phone, smart phone, personal digital assistant, tablet computer, and the like. Connected device 1550 represents a device with a large screen 1555. For example, connected device 1550 could be a television screen (e.g., a smart television) or another device connected to a television (e.g., a set-top box or gaming console) or the like. One or more of the connected devices 1530, 1540, 1550 can include touch screen capabilities. Touchscreens can accept input in different ways. For example, capacitive touchscreens detect touch input when an object (e.g., a fingertip or stylus) distorts or interrupts an electrical current running across the surface. As another example, touchscreens can use optical sensors to detect touch input when beams from the optical sensors are interrupted. Physical contact with the surface of the screen is not necessary for input to be detected by some touchscreens. Each of the touch screens can support scrollable lists, as described herein.

Services can be provided by the cloud 1510 through service providers 1520, or through other providers of online services (not depicted). For example, cloud services can be customized to the screen size, display capability, and/or touch screen capability of a particular connected device (e.g., connected devices 1530, 1540, 1550).

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable storage media (e.g., non-transitory computer-readable media, such as one or more optical media discs, volatile memory components (such as DRAM or SRAM), or nonvolatile memory components (such as hard drives)) and executed on a computer (e.g., any commercially available computer, including smart phones or other mobile devices that include computing hardware). Any of the computer-executable instructions for implementing the disclosed techniques as well as any data created and used during implementation of the disclosed embodiments can be stored on one or more computer-readable media (e.g., non-transitory computer-readable media). The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope of these claims.

We claim:

1. A method of displaying a list in a user interface, comprising:
displaying a first list in alphabetical order;
displaying selectable headings associated with the first list;
receiving an input selection of one of the headings, and, in response thereto, displaying a second list that includes the headings from the first list;
receiving an input selection of one of the headings in the second list, and in response thereto, jumping to the selected heading in the first list;
scrolling the first list and persistently displaying at least one of the headings so that the second list is easily accessible.

2. The method of claim 1, further including determining a length of the first list and suppressing the headings if the first list is less than a predetermined length.

3. The method of claim 1, wherein persistently displaying includes maintaining at least one selectable heading in a position at a top of the first list.

4. The method of claim 1, wherein the first list is a list of names.

5. The method of claim 4, wherein the list of names is derived from a list of contacts.

6. The method of claim 1, further including transitioning displaying from one heading to a next heading by partially displaying one of the headings as the list is scrolled.

7. The method of claim 1, wherein the second list is displayed in a separate window from the first list.

8. The method of claim 1, wherein persistently displaying includes moving at least one heading up or down on a list as the list is being scrolled so that the at least one heading is always displayed.

9. A computer-readable storage having instructions thereon to perform a method, comprising:
displaying a first list;
displaying selectable headings integrated into the first list so that when a heading is selected on a second list is displayed;
receiving a selection of a heading in the second list and jumping to a different point in the first list; and
persistently displaying at least one heading in the first list at the top of the first list so that access to the second list is readily available.

10. The computer-readable storage of claim 9, wherein the headings are integrated into the first list to separate the first list into logical parts.

11. The computer-readable storage of claim 9, wherein the first list is a list of names and the headings are selected from a group consisting of a single letter to alphabetize the names, dates, and categories.

12. The computer-readable storage of claim 9, wherein the first list and second list are displayed in separate windows.

13. The computer-readable storage of claim 9, further including suppressing the headings if the first list is below a predetermined number of entries.

14. The computer-readable storage of claim 9, wherein persistently displaying includes changing a headings relative position in the first list to ensure that it is displayed when the list is scrolled.

15. The computer-readable storage of claim 9, wherein the first and second list are displayed in a same window.

16. A method of displaying a list in a user interface, comprising:
displaying a first list of contacts in alphabetical order;
displaying selectable headings integrated into the first list, the headings each being a letter to divide the first list in sections based on the first letter of the contact;
receiving input selecting one of the headings, and, in response thereto, displaying a second list, which is the headings from the first list;
receiving input selecting one of the headings in the second list;
jumping to a position in the first list corresponding to the selected heading;
persistently displaying at least one of the headings by changing position of the at least one heading relative to the contacts in the first list so that the at least one heading is displayed as the contacts are scrolled.

17. The method of claim 16, further including determining a number of contacts in the first list and suppressing the headings if the number of contacts is less than a predetermined number.

18. The method of claim 16, wherein the scrolling includes moving the list up or down on the display in response to user input.

19. The method of claim 16, further including transitioning displaying from one heading to a next heading to minimize a number of headings displayed as the list of contacts are scrolled.

20. The method of claim 16, wherein the first and second list are in separate windows.
